(19) United States
(12) Patent Application Publication
(10) Pub. No.: US 2009/0132295 A1
(43) Pub. Date: May 21, 2009

(54) Method of Reducing Malpractice Premiums for Physicians

(76) Inventors: Robert Grgory Pecan, Egg Harbor City, NJ (US); Geoffrey Robert Pecan, Beverly, MA (US)

Correspondence Address: Daniel N. Smith, 15 Church Street, Salem, MA, 01970, US

(21) Appl. No.: 12/275,148

(22) Filed: Nov. 20, 2008

Related U.S. Application Data
(60) Provisional application No. 60/989,436, filed on Nov. 20, 2007.

(51) Int. Cl. G06Q 40/00

(52) U.S. Cl. 705/4

(57) ABSTRACT

Methods of reducing medical malpractice insurance premiums for physicians or hospitals and reducing health care costs for employees covered by an employer's health plan. Employees waive their rights to litigate any potential medical malpractice claims. The reduction of risk of potential malpractice claims reduces the cost of insuring medical malpractice policies. These reduced costs for the insurance underwriters are passed as savings to employees in the form of reduced health insurance premiums and physicians in the form of reduced malpractice insurance premiums.

### CROSS REFERENCE TO RELATED APPLICATION

This application claims the benefit of U.S. Provisional Application No. 60/989,436 filed on Nov. 20, 2007, the contents of which are incorporated herein by reference.

### FIELD OF THE INVENTION

The present invention relates to methods for reducing malpractice premiums for medical service providers and reducing health insurance premiums for individuals covered by private health insurance plans.

### BACKGROUND OF INVENTION

Health insurance is a contractual relationship embodied in a health insurance policy contract between a Health Insurance Provider and a policy holder. In this contractual relationship, the policy holder makes periodic (usually monthly) payments, often called premiums, to a Health Insurance Provider under the terms of a health insurance policy contract. The Health Insurance Provider agrees to pay certain health care costs incurred by the policy holder. Specifically, the Health Insurance Provider may fully or partially pay for doctor visits and medical treatments of the policy holder. The Health Insurance Provider may also contractually guarantee to pay any high or unexpected health care costs for the policy holder up to a defined monetary amount.

Under most of these health insurance contracts, the policy holder must pay out of pocket for certain portions of their health care costs. For example, a policy holder may have to pay a deductible or a certain amount for any unexpected or high health care costs. Anything above this deductible amount is paid by the Health Insurance Provider, up to a payment ceiling. In addition, a policy holder must usually have to make out of pocket payments for each visit to a physician's office or to obtain prescription drugs. These payments are usually called co-payments. A copayment usually must be made by the policy holder each time the visit occurs or the prescription drug is obtained.

Health Insurance Providers sell health insurance plans to large companies. These large companies purchase these plans on behalf of their employees. The premium or payment for the health insurance contract to the Health Insurance Provider may be fully or partially paid by the employer. The remaining payment due on the health insurance plan may spread out among the employees. Each employee is responsible for paying his or her share of the premium under the health insurance contract.

This typical health insurance contractual relationship is shown in FIG. 1. In this relationship, an Insurance Underwriter calculates the overall risk of health care costs for the employees of a given company to develop a cost of underwriting an Insurance Plan. The Insurance Underwriter negotiates this cost with a Health Insurance Provider. In turn, the Health Insurance Provider negotiates with the company to sell a health insurance plan for the company's employees. The company often apportions the cost of the entire health care plan by its number of employees. Each employee must then pay a portion of his or her share of the health insurance plan costs. This portion of the employee's share of the health care costs paid by the employee is called an employee premium. In addition to paying an employee premium, employees are often required to make defined out of pocket co-payments for visits to the physician's office or for prescription drugs. Employees retain the right to sue the hospital or physician for any medical malpractice.

The Health Insurance Provider uses a portion of the income received from the health insurance plans to pay the remaining balance on each co-payment for every doctor's visit and prescription drugs. The Health Insurance Provider also uses a portion of this income to provide payments for certain medical treatments covered by the health insurance plan. These payments are called doctors fees. The Health Insurance Provider often negotiates the rates for doctors' fees. Doctors who agree to accept these rates are usually placed in an approved “network” of doctors whom the employees may visit and still be covered by the health insurance plan.

Health Insurance Providers reduce health care costs by several methods.

To lower health care costs, Health Insurance Providers spread the risk of high health care costs over large numbers of policy holders. Therefore, when one policy holder becomes ill and incurs large health care costs, the payments by the other healthy policy holders are used to pay the large health care costs of the sick policy holder. The Health Insurance Provider this pools the resources of many policy holders to offset the high costs of health care. Health Insurance Providers determine the cost of payments to purchase a health insurance plan based on an estimation of the overall risk of health care costs for a given group of policy holders (i.e. employees of a company.)

To further lower health care costs, Health Insurance Providers, with their large pool of policy holders, negotiate reduced doctor and hospital fees for their policy holders. Physicians and hospitals agree to accept reduced payments from Health Insurance Providers to have access to their large pool of policy holders. Every physician or hospital that agrees to the fees provided by the Health Insurance Providers will be listed in a “network.” It usually costs the policy holder more out of pocket to use a physician outside of this “network”. Thus, medical providers gain access to a larger patient base that has guaranteed, albeit reduced, payments for their medical services.

An another method now being employed to lower health care costs involves the use of preventative medicine and the encouragement of healthy lifestyle choices through lower premiums. Policy holders are given access to pre-paid physicals on a periodic basis. In addition, policy holders can reduce their premiums by avoiding smoking, attending approved exercise facilities, or losing weight.

Despite these efforts to reduce the costs of health care, health care costs are rising in the United States. Several reasons for this increase in health care costs include increased consumer demand; expensive new treatments; increased overall age of the population; and increased obesity.

Another reason for increased health care costs is the increased costs of medical professional liability (medical malpractice) insurance fees for physicians and hospitals. To offset these higher medical malpractice insurance fees, physicians and hospitals increase fees charged to patients and Health Insurance Providers for providing medical services.

Medical malpractice insurance is a contractual relationship embodied in a medical malpractice insurance contract between a Medical Malpractice Insurance Provider and a physician or hospital policy holder. In this contractual relationship, the physician or hospital policy holder makes periodic payments to a Medical Malpractice Insurance Provider under the terms of a medical malpractice insurance contract. The Medical Malpractice Insurance Provider agrees to pay for any medical malpractice claims and legal defenses made against the policy holding physician or hospital by a plaintiff.

Virtually all physicians are required by State law to be covered by medical malpractice insurance. Even if State law makes no such requirements, physicians will not have the privilege to see patients in hospitals without this type of insurance coverage. Physicians employed by hospitals or other entities may have medical malpractice insurance purchased for them. Premiums for medical malpractice insurance can vary based on the physician's specialty of practice and geographic location.

One of the major reasons that malpractice insurance rates have increased is the uncertainty of medical malpractice lawsuits and the uncertainty in the amount of damages awarded to plaintiffs in these lawsuits. Medical Malpractice Insurance Providers must charge higher premium costs to physicians and hospitals to pay for the costs of medical malpractice litigation, including the costs of settlement and awards.

In a medical malpractice lawsuit, a plaintiff may allege that he or she was injured by a physician or hospital staff by failing to follow the standard accepted procedures for diagnosis or treatment. A plaintiff has to prove four elements in a malpractice lawsuit: 1) the physician or hospital owned the plaintiff a legal of care or treatment; 2) this duty is breached when the physician or hospital staff failed to provide the accepted standard of care or treatment; 3) this breach caused the injury; and 4) the plaintiff suffered damages. It can take many years to resolve these liability claims since plaintiffs can wait several years after discovering an injury that allegedly results from the actions of the physician to file a claim against that physician.

Medical malpractice insurance rates have also increased due to the size of judgments awarded in medical malpractice litigation. There are several different types of monetary damages awarded in medical malpractice lawsuits. The plaintiff may be awarded damages for his or her economic losses including compensation for lost wages and other income including benefits such as pension contributions, medical care and expenses, custodial care, lost earning capacity, and funeral expenses if the injury resulted in death. The plaintiff may also be awarded monetary damages for his or her noneconomic losses including physical pain and suffering, mental distress and suffering, permanent impairment or loss of function, disfigurement, loss of the ability to enjoy life's pleasures, loss of consortium, and death. Furthermore, the courts can also order the payment of additional money to punish the defendants responsible for the injuries. This type of an award is called punitive damages.

The drastic rise is noneconomic and punitive damage awards in recent decades have resulted in very large premium increases for medical malpractice insurance. Medical Malpractice Insurance Providers must often carry a cash bond to cover any potentially successful medical malpractice claims. Premiums obtained from physicians and hospitals for medical malpractice insurance plans are used to fund these cash bonds.

The typical physician medical malpractice insurance contractual relationship is shown in FIG. 2. In this relationship, a Medical Malpractice Insurance Provider assesses the overall risk of medical malpractice based on a physician's specialty of practice and geographic location to develop a cost of underwriting a Medical Malpractice Insurance Plan. The Insurance Underwriter negotiates this cost with a Medical Malpractice Insurance Provider. In turn, the Medical Malpractice Provider negotiates with hospitals and physicians to sell a medical malpractice insurance plan. Unless the State has passed a Tort Reform Act, a patient of the doctor is not limited in damages in a malpractice suit against physicians.

The Medical Malpractice Insurance Provider uses a portion of the income received from the physician or hospital to fund a cash bond to cover any potentially successful medical malpractice claims against the physician or hospital.

### SUMMARY OF THE INVENTION

The subject invention discloses a method for calculating a reduction of medical malpractice insurance costs for a medical service provider comprising the steps of: calculating on a computer system a first cost of insuring the medical service provider against potential medical malpractice claims from a group of individuals; calculating on a computer system a second cost of a premium for medical malpractice insurance for the medical service provider using the first cost; calculating on a computer system a third cost of insuring health care costs for the group of individuals in a health insurance plan; calculating on a computer system a fourth cost of an individual premium for each individual in the group of individuals in the health insurance plan using the third cost; preparing and including a medical malpractice lawsuit waiver in the health insurance plan, wherein each individual in the group of individuals must either accept or reject the medical malpractice lawsuit waiver as a condition of acceptance into the health insurance plan; calculating on a computer system a fifth cost of insuring the medical service provider against potential medical malpractice claims for the group of individuals containing a first set of individuals that signed the medical malpractice lawsuit waiver and a second set of individuals that did not sign the medical malpractice lawsuit waiver; calculating on a computer system the difference between the first cost and the fifth cost of insuring the medical service provider against potential medical malpractice claims from the group of individuals; calculating on a computer system a reduction of the fourth cost of the individual premium for each individual in the first set of individuals that signed the medical malpractice lawsuit waiver by a first percentage; and calculating on a computer system a reduction of the second cost of the medical malpractice premium for the medical service provider by a second percentage.

In one embodiment of the subject invention, the first percentage is from 10 to 50%.

In another embodiment of the subject invention, the second percentage is from 10 to 50%.

In a further embodiment of the subject invention, the group of individuals is employees of a business entity.

In another embodiment of the subject invention, the group of individuals is employees of 2 or more business entities.

In one embodiment of the subject invention, the group of individuals must consent to video capture of any surgeries paid in any part by the health insurance plan as a condition of acceptance into the health insurance plan.

In another embodiment of the subject invention, the video capture is contained on video film.

In a further embodiment of the subject invention, the video capture is contained on digital film.

In one embodiment of the subject invention, the group of individuals must consent to review of any medical malpractice claims by an arbitration board as a condition of acceptance into the health insurance plan.

In another embodiment of the subject invention, the arbitration board comprises physicians of several medical specialties.

In one embodiment of the subject invention, the arbitration board comprises at least two physicians from the hospital from which the medical malpractice claims arise.

In a further embodiment of the subject invention, the medical service provider is a physician.

In one embodiment of the subject invention, the medical service provider is a hospital.

In another embodiment of the subject invention, the medical service provider is engaged in a practice area selected from the group consisting of allergy and immunology, anesthesiology, audiology, cardiology, colon/rectal surgery, dermatological surgery, dermatology, diabetology, emergency medicine, endocrinology, family and general medicine, fertility medicine, gastroenterology, general internal medicine, general pediatrics, general surgery, geriatric medicine, hand surgery, hematology, hepatology, neonatology, nephrology, neurology, neurosurgery, oncology, obstetrics and gynecology, ophthalmology, orthopedic surgery, osteopathic medicine, otolaryngology, pathology, pediatric surgery, physical medicine/rehabilitation, plastic and reconstructive surgery, podiatric medicine, preventative medicine, proctology, prosthetics, psychiatry, pulmonary diseases, radiology, reproductive medicine, rheumatology, sports medicine, thoracic surgery, vascular surgery, urology, occupational medicine, chiropractic medicine, endodontics, dentofacial orthopedics, General dentistry, pediatric dentistry, periodontics, prosthodontics, orthodontics, oral and maxillofacial surgery, oral pathology, oral radiology, oral surgery, pharmacy, and pharmacology.

In one embodiment of the subject invention, the invention comprises the further step of calculating on a computer system a sixth cost for medical services provided by the medical service provider under the health insurance plan.

In a further embodiment of the subject invention, the invention comprises the further step of calculating on a computer system a reduction of a seventh cost of individual copayments for each individual in the first set of individuals that signed the medical malpractice lawsuit waiver by a third percentage.

In one embodiment of the subject invention, the third percentage is from 10 to 100%.

The subject invention also discloses a method for calculating a reduction of medical malpractice insurance costs for a medical service provider comprising the steps of: calculating on a computer system a first cost of insuring the medical service provider against potential medical malpractice claims from a group of individuals; calculating on a computer system a second cost of a premium for medical malpractice insurance for the medical service provider using the first cost; calculating on a computer system a third cost of insuring health care costs for the group of individuals in a health insurance plan; calculating on a computer system a fourth cost of an individual premium for each individual in the group of individuals in the health insurance plan using the third cost; preparing and including a medical malpractice lawsuit waiver in the health insurance plan, wherein each individual in the group of individuals must either accept or reject the medical malpractice lawsuit waiver as a condition of acceptance into the health insurance plan; receiving a first indication of a first set of individuals from the group of individuals that signed the medical malpractice lawsuit waiver; receiving a second indication of a second set of individuals from the group of individuals that did not sign the medical malpractice lawsuit waiver; calculating on a computer system a fifth cost of insuring the medical service provider against potential medical malpractice claims for the group of individuals from the first indication of the first set of individuals and the second indication of the second set of individuals; calculating on a computer system the difference between the first cost and the fifth cost of insuring the medical service provider against potential medical malpractice claims from the group of individuals; calculating on a computer system a reduction of the fourth cost of the individual premium for each individual in the first set of individuals that signed the medical malpractice lawsuit waiver by a first percentage; and calculating on a computer system a reduction of the second cost of the medical malpractice premium for the medical service provider by a second percentage.

The subject invention also discloses a computer-readable medium encoded with processing instructions for implementing a method, performed by a computer, for calculating a reduction of medical malpractice insurance costs for a medical service provider comprising a computer usable medium having computer readable program code thereon, the computer readable program code comprising: program code for calculating a first cost of insuring the medical service provider against potential medical malpractice claims from a group of individuals; program code for calculating a second cost of a premium for medical malpractice insurance for the medical service provider using the first cost; program code for calculating a third cost of insuring health care costs for the group of individuals in a health insurance plan; program code for calculating a fourth cost of an individual premium for each individual in the group of individuals in the health insurance plan using the third cost; program code for preparing a medical malpractice lawsuit waiver in the health insurance plan; program code for receiving a first indication of a first set of individuals from the group of individuals that signed the medical malpractice lawsuit waiver; program code for receiving a second indication of a second set of individuals from the group of individuals that did not sign the medical malpractice lawsuit waiver; program code for calculating a fifth cost of insuring the medical service provider against potential medical malpractice claims for the group of individuals from the first indication of the first set of individuals and the second indication of the second set of individuals; program code for calculating the difference between the first cost and the fifth cost of insuring the medical service provider against potential medical malpractice claims from the group of individuals; program code for calculating a reduction of the fourth cost of the individual premium for each individual in the first set of individuals that signed the medical malpractice lawsuit waiver by a first percentage; and program code for calculating a reduction of the second cost of the medical malpractice premium for the medical service provider by a second percentage.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

For a better understanding of the invention, its operating advantages and the specific objects attained by its uses, reference should be made to the accompanying drawings and descriptive matter in which there are illustrated preferred embodiments of the invention. Other features and advantages of the present invention will become apparent from the following description of the preferred embodiment(s), taken in conjunction with the accompanying drawings, which illustrate, by way of example, the principles of the invention.

### BRIEF DESCRIPTION OF DRAWINGS

FIG. 1 illustrates the typical health insurance contractual relationships between Insurance providers and health insurance plan recipients.

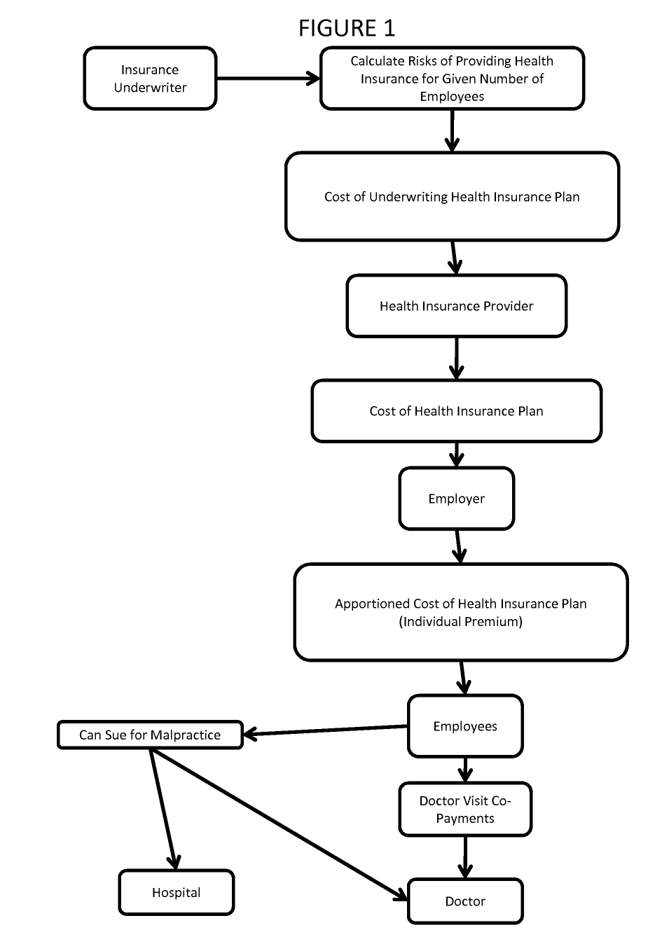

FIG. 2 illustrates the typical medical malpractice insurance contractual relationships between Insurance providers and medical malpractice plan recipients.

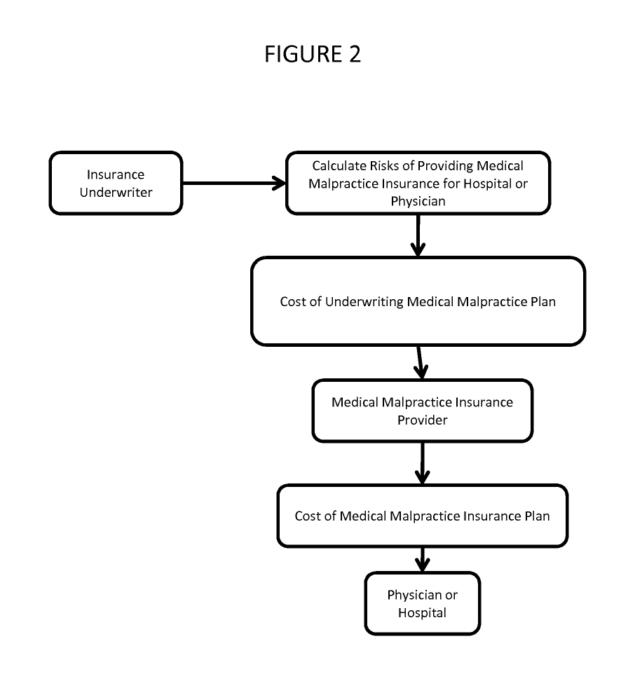

FIG. 3 illustrates a novel method of reducing health insurance premiums for employees covered under a health insurance plan purchased by their employers by signing a waiver of any medical malpractice claims.

FIG. 4 illustrates how the novel method of reducing health insurance premiums for employees covered under a health insurance plan purchased by their employers by signing a waiver of any medical malpractice claims reduces medical malpractice insurance premiums for physicians.

FIG. 5 illustrates how the novel method of reducing health insurance premiums for employees covered under a health insurance plan purchased by their employers by signing a waiver of any medical malpractice claims reduces costs for medical malpractice insurance providers.

FIG. 6 illustrates how the novel method of reducing health insurance premiums for employees covered under a health insurance plan purchased by their employers by signing a waiver of any medical malpractice claims reduces medical malpractice insurance premiums for hospitals.

FIG. 7 illustrates how the novel method of reducing health insurance premiums for employees covered under a health insurance plan purchased by their employers by signing a waiver of any medical malpractice claims reduces costs for medical malpractice insurance underwriters.

### DETAILED DESCRIPTION OF THE PREFERRED EMBODIMENTS

The novel method of the subject application modifies currently existing plans to reduce medical malpractice insurance premiums for physicians, while reducing health care costs for employers and employees.

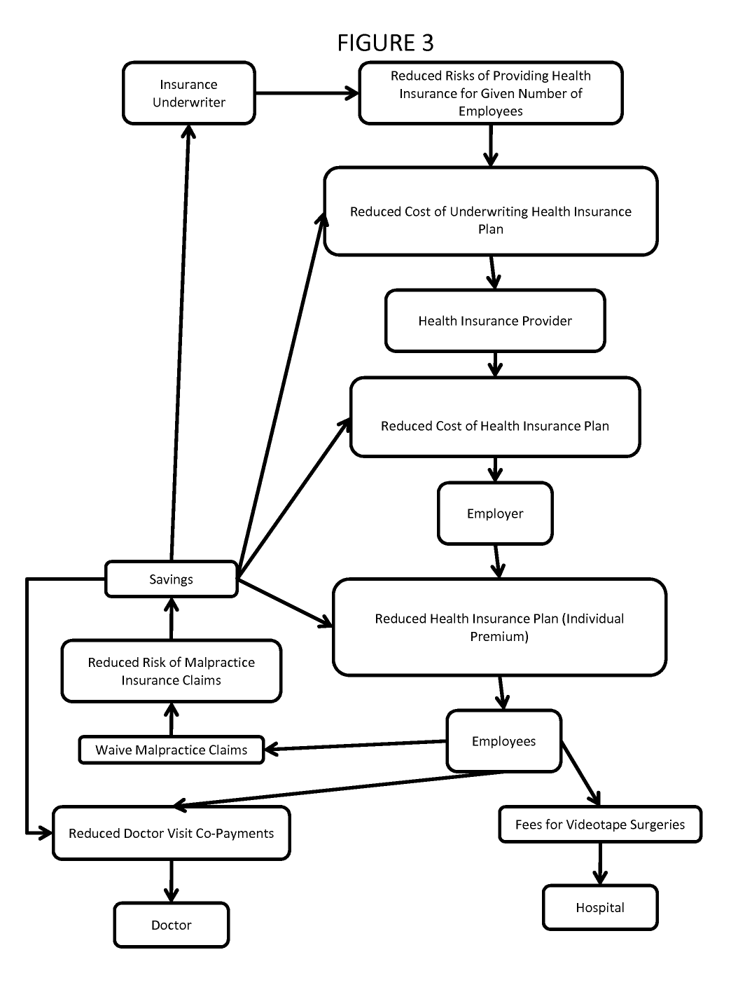

FIG. 3 illustrates a method of the invention. In the subject invention, an Insurance Underwriter underwrites 1) health insurance policies for companies and 2) medical malpractice insurance policies for physicians and hospitals. Employees covered by a health insurance policy, underwritten by the Insurance Underwriter, are given the option to waive their rights to litigate any potential medical malpractice claims. Each employee that waives their rights to litigate any potential medical malpractice claims reduces the risk of insuring medical malpractice claims for the Insurance Underwriter. Medical malpractice premiums are lowered by reducing or eliminating the uncertainties of medical malpractice lawsuits and damages awarded to plaintiffs in these lawsuits. A reduced risk of insuring medical malpractice claims decreases the costs of insuring medical malpractice policies for physicians or hospitals. These savings for the Insurance Underwriter are passed, in part, to the employees that waive their rights to litigate any potential medical malpractice claims in the form of reduced health insurance premiums and reduced copayments. Any employee that does not waiver his or rights to litigate any potential medical malpractice claims is charged the full premium price for the health insurance policy.

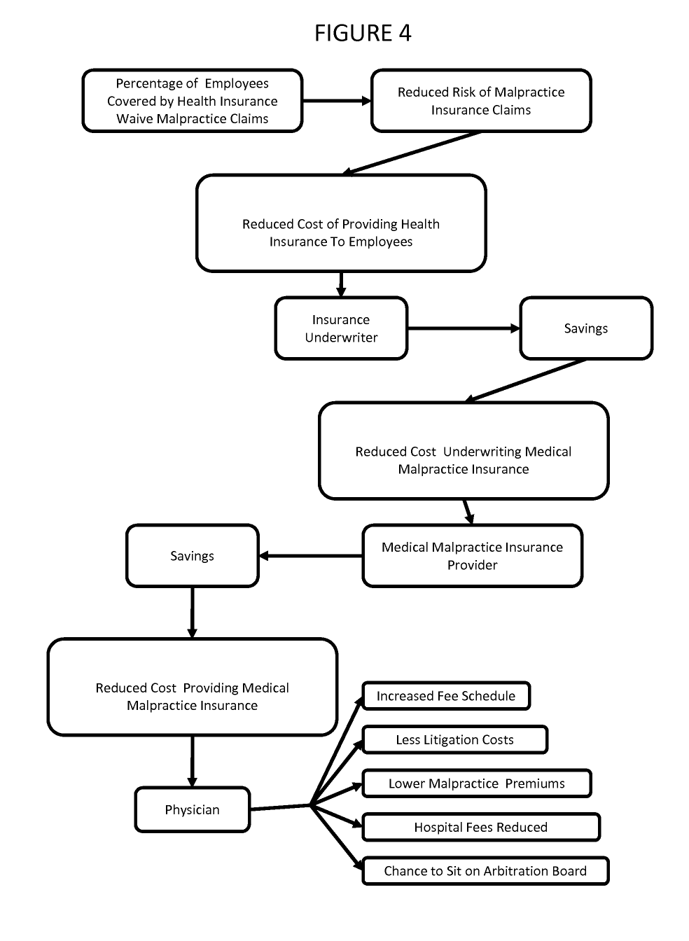

FIG. 4 illustrates the effect of the subject invention on physicians. Employees that waive their rights to litigate any potential medical malpractice claims reduce the risks of insuring medical malpractice policies. These reduced risks lead to reduced costs for the Insurance Underwriter. These savings for the Insurance Underwriter are passed, in part, to the physician in the form of reduced medical malpractice insurance premiums. These savings are also used, in part, to increase the doctor's fee schedule for certain medical procedures. Physicians will also receive a reduction in out of pocket litigation costs.

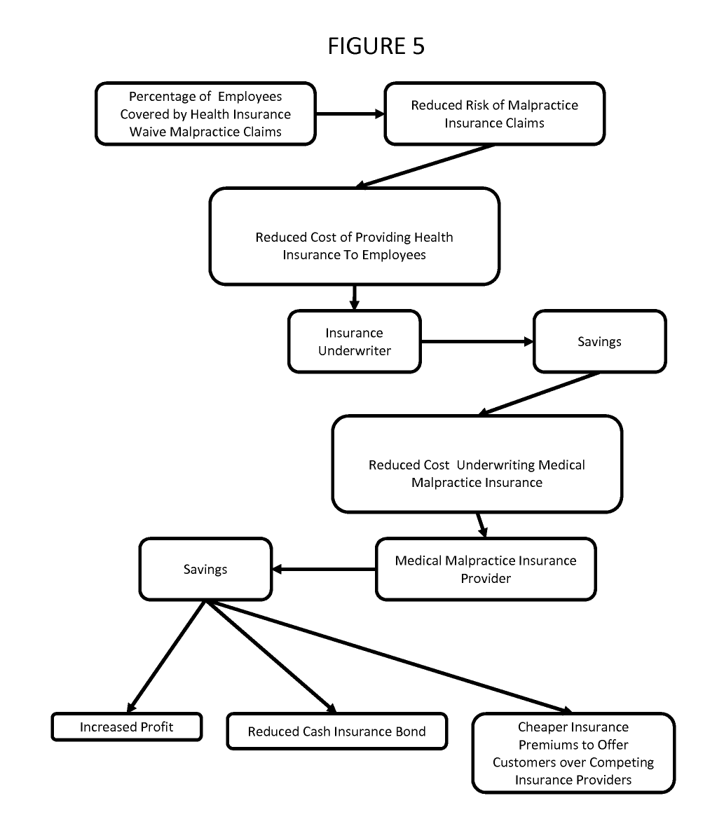

FIG. 5 illustrates the effect of the subject invention on Medical Malpractice Insurance Providers. Employees that waive their rights to litigate any potential medical malpractice claims reduce the risks of insuring medical malpractice policies. These reduced risks lead to reduced costs for the Insurance Underwriter, which are passed to Medical Malpractice Insurance Providers. These savings are passed, in part to profits, reduced cash bonds to maintain to cover any potentially successful medical malpractice claims, and to offer cheaper, more competitive insurance policy rates to potential customers.

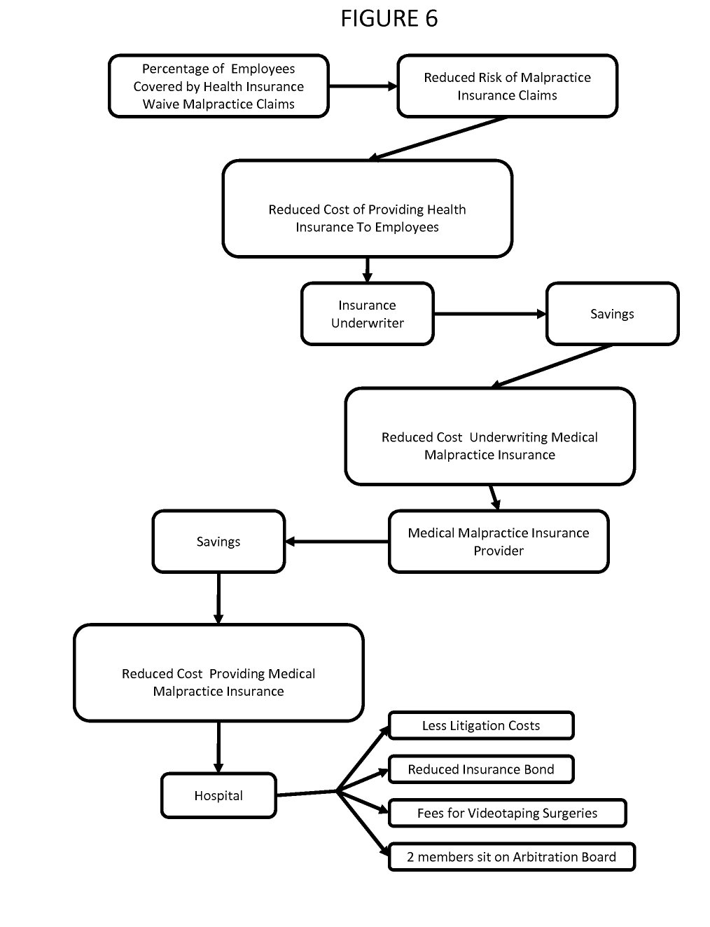

FIG. 6 illustrates the effect of the subject invention on hospitals. Employees that waive their rights to litigate any potential medical malpractice claims reduce the risks of insuring medical malpractice policies. These reduced risks lead to reduced costs for the Insurance Underwriter. These savings for the Insurance Underwriter are passed, in part, to hospitals in the form of reduced medical malpractice insurance premiums. These savings are also used, in part, to increase the hospital's fee schedule for certain medical procedures. Hospitals will also receive a reduction in out of pocket litigation costs. Even further, hospitals can reduce any required insurance bond.

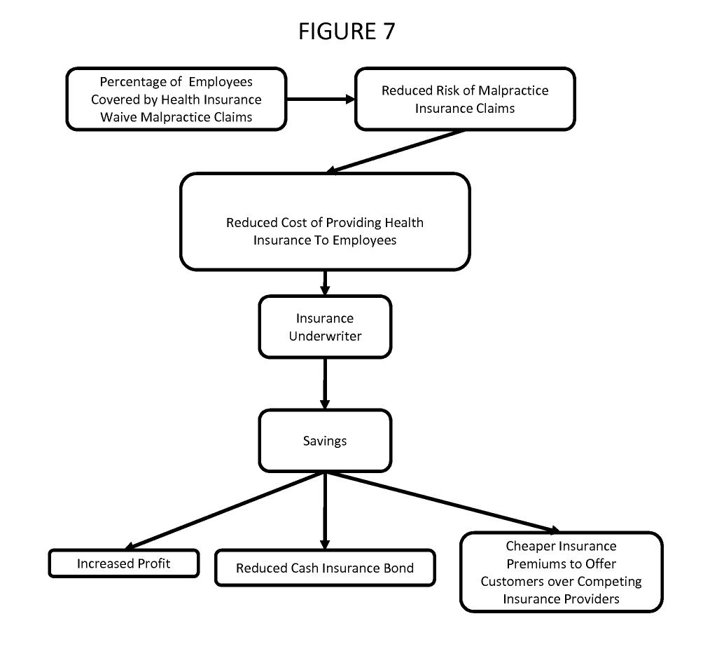

FIG. 7 illustrates the effect of the subject invention on Insurance Underwriters. Employees that waive their rights to litigate any potential medical malpractice claims reduce the risks of insuring medical malpractice policies. These reduced risks lead to reduced costs for the Insurance Underwriter. These savings for the Insurance Underwriter are passed, in part, to profits. In addition, Medical Malpractice Insurance Providers have reduced cash bonds to maintain to cover any potentially successful medical malpractice claims. These savings are also used, in part, to offer cheaper, more competitive insurance policy rates to potential customers.

One embodiment of the subject invention is a method of reducing the costs of insuring a medical service provider against potential claims of medical malpractice comprising the steps of: a) determining a first cost of insuring the medical service provider against potential medical malpractice claims from a group of individuals; b) determining a second cost of a premium for medical malpractice insurance for the medical service provider using the first cost; c) determining a third cost of insuring health care costs for the group of individuals in a health insurance plan; d) determining a fourth cost of an individual premium for each individual in the group of individuals in the health insurance plan; e) preparing and including a medical malpractice lawsuit waiver in the health insurance plan; f) requiring each individual in the group of individuals to either accept or reject the medical malpractice lawsuit waiver as a condition of acceptance into the health insurance plan; g) determining a fifth cost of insuring the medical service provider against potential medical malpractice claims for the group of individuals containing a first set of individuals that signed the medical malpractice lawsuit waiver and a second set of individuals that did not sign the medical malpractice lawsuit waiver; h) determining the difference between the first cost and the fifth cost of insuring the medical service provider against potential medical malpractice claims from the group of individuals; i) reducing the fourth cost of the individual premium for each individual in the first set of individuals that signed the medical malpractice lawsuit waiver by a first percentage; and j) reducing the second cost of the medical malpractice premium for the medical service provider by a second percentage.

In one embodiment of this invention the insurance bond for the Insurance Providers is reduced. Premiums for employees whom waive medical malpractice claims are reduced. Companies shared cost of their health insurance plans is reduced. Medical Malpractice premiums are reduced, resulting in lower health care costs.

In a further embodiment of the subject invention, the group of individuals is employees of a business entity. In an embodiment of the subject invention, the group of individuals is employees of 2 or more business entities.

In one embodiment of this invention, employees will receive a 10% to 50% reduction in their monthly premiums for their health insurance plans. In another embodiment of this invention, employees will receive a 10% reduction in their monthly premiums. In yet another embodiment of this invention, employees will receive a 15% reduction in their monthly premiums. In a further embodiment of this invention, employees will receive a 20% reduction in their monthly premiums. In another embodiment of this invention, employees will receive a 25% reduction in their monthly premiums. In yet another embodiment of this invention, employees will receive a 30% reduction in their monthly premiums. In a further embodiment of this invention, employees will receive a 35% reduction in their monthly premiums. In another embodiment of this invention, employees will receive a 40% reduction in their monthly premiums. In yet embodiment of this invention, employees will receive a 45% reduction in their monthly premiums. In a further embodiment of this invention, employees will receive a 50% reduction in their monthly premiums.

In a further embodiment of the subject invention, the medical service provider is a physician. In another embodiment of the subject invention, the medical service provider is a hospital.

In one embodiment of this invention, physicians will receive a 10% to 50% reduction in their monthly premiums for their medical malpractice insurance plans. In another embodiment of this invention, physicians will receive a 10% reduction in their monthly premiums. In yet another embodiment of this invention, physicians will receive a 15% reduction in their monthly premiums. In a further embodiment of this invention, physicians will receive a 20% reduction in their monthly premiums. In another embodiment of this invention, physicians will receive a 25% reduction in their monthly premiums. In yet another embodiment of this invention, physicians will receive a 30% reduction in their monthly premiums. In a further embodiment of this invention, physicians will receive a 35% reduction in their monthly premiums. In another embodiment of this invention, physicians will receive a 40% reduction in their monthly premiums. In yet embodiment of this invention, physicians will receive a 45% reduction in their monthly premiums. In a further embodiment of this invention, physicians will receive a 50% reduction in their monthly premiums.

In one embodiment of this invention, hospitals will receive a 10% to 50% reduction in their monthly premiums for their medical malpractice insurance plans. In another embodiment of this invention, hospitals will receive a 10% reduction in 0their monthly premiums. In yet another embodiment of this invention, hospitals will receive a 15% reduction in their monthly premiums. In a further embodiment of this invention, hospitals will receive a 20% reduction in their monthly premiums. In another embodiment of this invention, hospitals will receive a 25% reduction in their monthly premiums. In yet another embodiment of this invention, hospitals will receive a 30% reduction in their monthly premiums. In a further embodiment of this invention, hospitals will receive a 35% reduction in their monthly premiums. In another embodiment of this invention, hospitals will receive a 40% reduction in their monthly premiums. In yet embodiment of this invention, hospitals will receive a 45% reduction in their monthly premiums. In a further embodiment of this invention, hospitals will receive a 50% reduction in their monthly premiums.

In one embodiment of the subject invention, all health insurance policy holders will provide consent that all surgeries performed will be videotaped. Videotaping may be performed by analog cameras and stored on film or performed by digital cameras and digitally stored. In another embodiment of the subject invention, videotaped surgeries will be maintained for 1 to 5 years by a hospital before being permanently destroyed. In yet another embodiment of the subject invention, hospitals will receive videotaping and storage fees from health insurance policy holders. In a further embodiment of the subject invention, the policy holders may reduce their videotaping fees by giving consent to the hospital to use the tape for teaching purposes.

Another embodiment of the subject invention comprises the further step of increasing a sixth cost for medical services provided to the medical service provider under the health insurance plan.

An embodiment of the subject invention comprises the further step of reducing a seventh cost of individual copayments for each individual in the first set of individuals that signed the medical malpractice lawsuit waiver by a third percentage. In one embodiment of the subject invention the third percentage is from 10 to 100%.

In one embodiment of this invention, doctor fees for medical treatments are increased. In another embodiment of this invention, hospital fees for physicians are reduced.

In yet another embodiment of the subject invention an insurance bond for a hospital is reduced. In another embodiment of this invention hospital fees are increased.

In one embodiment of the subject invention, an arbitration board of review will be created. This board will review all medical malpractice claims brought by a plaintiff, including a review of the videotaped surgeries of the plaintiff. The Board is made up of individuals, representing their perspective services to reach an amicable resolution. A determination will have to be reached within an allotted time to cause less harm for both parties.

In one embodiment of the subject invention, the board will comprise numerous independent specialists, up to 100. Upon the filing of a medical malpractice claim, 10 to 20 board members, including 2 members from the hospital in which the procedure was performed, will determine if the operating physician breached the standard of care in treating the plaintiff. In one embodiment of the subject invention, 10 board members will be selected from each of the following practice areas: general surgery, general practice, plastic surgery, obstetrics and gynecology, orthopedics, pharmacy, anesthesiology, pediatrics, and other specialty areas.

Embodiments of the subject invention may be employed by physicians, hospitals or other medical service providers in the following practice areas: allergy and immunology, anesthesiology, audiology, cardiology, colon/rectal surgery, dermatological surgery, dermatology, diabetology, emergency medicine, endocrinology, family and general medicine, fertility medicine, gastroenterology, general internal medicine, general pediatrics, general surgery, geriatric medicine, hand surgery, hematology, hepatology, neonatology, nephrology, neurology, neurosurgery, oncology, obstetrics and gynecology, ophthalmology, orthopedic surgery, osteopathic medicine, otolaryngology, pathology, pediatric surgery, physical medicine/rehabilitation, plastic and reconstructive surgery, podiatric medicine, preventative medicine, proctology, prosthetics, psychiatry, pulmonary diseases, radiology, reproductive medicine, rheumatology, sports medicine, thoracic surgery, vascular surgery, urology, occupational medicine, chiropractic medicine, endodontics, dentofacial orthopedics, General dentistry, pediatric dentistry, periodontics, prosthodontics, orthodontics, oral and maxillofacial surgery, oral pathology, oral radiology, oral surgery, pharmacy, and pharmacology.

One of skill in the art will recognize that insurance is a regulated industry. One practicing the methods described and claimed herein will want to maintain compliance with all applicable local, state and federal regulations, to ensure that the insurance policy is properly presented to the insured, premiums are properly approved, underwriting properly occurs, all necessary regulatory approvals are in place, etc.

While particular embodiments of the present invention have been illustrated and described, it would be obvious to those skilled in the art that various other changes and modifications can be made without departing from the spirit and scope of the invention. Any of the aspects of the invention of the present invention found to offer advantages over the state of the art may be used separately or in any suitable combination to achieve some or all of the benefits of the invention disclosed herein.

### EXAMPLE 1

In this example, Company A contains 100,000 employees divided into three groups.

Group X comprises 60,000 of the 100,000 employees. All the members of Group X are under the age of 40. These employees represent 60% of the health insurance recipients.

Group Y comprises 15,000 of the 100,000 employees. All the members of Group Y are between the ages of 40 to 50. These employees represent 15% of the health insurance recipients.

Group Z comprises 25,000 of the 100,000 employees. All the members of Group Z are over the age of 50. These employees represent 25% of the health insurance recipients.

50,000 employees of Group X and 2,000 employees of Group Y sign the medical malpractice waiver. 10,000 employees of Group X, 8,000 employees of Group Y and 25,000 employees of Group z do not sign the medical malpractice waiver. Accordingly, 52,000 employees sign the medical malpractice waiver and 48,000 employees do not.

In this example, the health care insurance plan costs $100,000,000.00 a month for all 100,000 employees or $1,000.00 per month per employee. For the 48,000 employees who do not sign the medical malpractice waiver, this premium of $1,000.00 a month ($48,000,000.00 a month total) remains the same. For the 52,000 employees that do sign the waiver, the plan costs are reduced $30,000,000.00 a month or $576.00 a month per employee. In several embodiments of the subject invention, this savings on each monthly premium will be passed to the physicians, the Medical Malpractice Insurance Provider, hospitals and the employee.

What is claimed is:

1. A method for calculating a reduction of medical malpractice insurance costs for a medical service provider comprising the steps of:
a) calculating on a computer system a first cost of insuring the medical service provider against potential medical malpractice claims from a group of individuals;
b) calculating on a computer system a second cost of a premium for medical malpractice insurance for the medical service provider using the first cost;
c) calculating on a computer system a third cost of insuring health care costs for the group of individuals in a health insurance plan;
d) calculating on a computer system a fourth cost of an individual premium for each individual in the group of individuals in the health insurance plan using the third cost;
e) preparing and including a medical malpractice lawsuit waiver in the health insurance plan, wherein each individual in the group of individuals must either accept or reject the medical malpractice lawsuit waiver as a condition of acceptance into the health insurance plan;
f) calculating on a computer system a fifth cost of insuring the medical service provider against potential medical malpractice claims for the group of individuals containing a first set of individuals that signed the medical malpractice lawsuit waiver and a second set of individuals that did not sign the medical malpractice lawsuit waiver;
g) calculating on a computer system the difference between the first cost and the fifth cost of insuring the medical service provider against potential medical malpractice claims from the group of individuals;
h) calculating on a computer system a reduction of the fourth cost of the individual premium for each individual in the first set of individuals that signed the medical malpractice lawsuit waiver by a first percentage; and
i) calculating on a computer system a reduction of the second cost of the medical malpractice premium for the medical service provider by a second percentage.

2. The method of claim 1, wherein the first percentage is from 10 to 50%.

3. The method of claim 1, wherein the second percentage is from 10 to 50%.

4. The method of claim 1, wherein the group of individuals is employees of a business entity.

5. The method of claim 1, wherein the group of individuals is employees of 2 or more business entities.

6. The method of claim 1, wherein the group of individuals must consent to video capture of any surgeries paid in any part by the health insurance plan as a condition of acceptance into the health insurance plan.

7. The method of claim 6, wherein the video capture is contained on video film.

8. The method of claim 6, wherein the video capture is contained on digital film.

9. The method of claim 1, wherein the group of individuals must consent to review of any medical malpractice claims by an arbitration board as a condition of acceptance into the health insurance plan.

10. The method of claim 9, wherein the arbitration board comprises physicians of several medical specialties.

11. The method of claim 9, wherein the arbitration board comprises at least two physicians from the hospital from which the medical malpractice claims arise.

12. The method of claim 1, wherein the medical service provider is a physician.

13. The method of claim 1, wherein the medical service provider is a hospital.

14. The method of claim 1, wherein the medical service provider is engaged in a practice area selected from the group consisting of allergy and immunology, anesthesiology, audiology, cardiology, colon/rectal surgery, dermatological surgery, dermatology, diabetology, emergency medicine, endocrinology, family and general medicine, fertility medicine, gastroenterology, general internal medicine, general pediatrics, general surgery, geriatric medicine, hand surgery, hematology, hepatology, neonatology, nephrology, neurology, neurosurgery, oncology, obstetrics and gynecology, ophthalmology, orthopedic surgery, osteopathic medicine, otolaryngology, pathology, pediatric surgery, physical medicine/rehabilitation, plastic and reconstructive surgery, podiatric medicine, preventative medicine, proctology, prosthetics, psychiatry, pulmonary diseases, radiology, reproductive medicine, rheumatology, sports medicine, thoracic surgery, vascular surgery, urology, occupational medicine, chiropractic medicine, endodontics, dentofacial orthopedics, General dentistry, pediatric dentistry, periodontics, prosthodontics, orthodontics, oral and maxillofacial surgery, oral pathology, oral radiology, oral surgery, pharmacy, and pharmacology.

15. The method of claim 1, comprising the further step of calculating on a computer system a sixth cost for medical services provided by the medical service provider under the health insurance plan.

16. The method of claim 1, comprising the further step of calculating on a computer system a reduction of a seventh cost of individual copayments for each individual in the first set of individuals that signed the medical malpractice lawsuit waiver by a third percentage.

17. The method of claim 16, wherein the third percentage is from 10 to 100%.

18. A method for calculating a reduction of medical malpractice insurance costs for a medical service provider comprising the steps of:
a) calculating on a computer system a first cost of insuring the medical service provider against potential medical malpractice claims from a group of individuals;
b) calculating on a computer system a second cost of a premium for medical malpractice insurance for the medical service provider using the first cost;
c) calculating on a computer system a third cost of insuring health care costs for the group of individuals in a health insurance plan;
d) calculating on a computer system a fourth cost of an individual premium for each individual in the group of individuals in the health insurance plan using the third cost;
e) preparing and including a medical malpractice lawsuit waiver in the health insurance plan, wherein each individual in the group of individuals must either accept or reject the medical malpractice lawsuit waiver as a condition of acceptance into the health insurance plan;
f) receiving a first indication of a first set of individuals from the group of individuals that signed the medical malpractice lawsuit waiver;
g) receiving a second indication of a second set of individuals from the group of individuals that did not sign the medical malpractice lawsuit waiver;
h) calculating on a computer system a fifth cost of insuring the medical service provider against potential medical malpractice claims for the group of individuals from the first indication of the first set of individuals and the second indication of the second set of individuals;
i) calculating on a computer system the difference between the first cost and the fifth cost of insuring the medical service provider against potential medical malpractice claims from the group of individuals;
j) calculating on a computer system a reduction of the fourth cost of the individual premium for each individual in the first set of individuals that signed the medical malpractice lawsuit waiver by a first percentage; and
k) calculating on a computer system a reduction of the second cost of the medical malpractice premium for the medical service provider by a second percentage.

19. A computer-readable medium encoded with processing instructions for implementing a method, performed by a computer, for calculating a reduction of medical malpractice insurance costs for a medical service provider comprising a computer usable medium having computer readable program code thereon, the computer readable program code comprising:
a) program code for calculating a first cost of insuring the medical service provider against potential medical malpractice claims from a group of individuals;
b) program code for calculating a second cost of a premium for medical malpractice insurance for the medical service provider using the first cost;
c) program code for calculating a third cost of insuring health care costs for the group of individuals in a health insurance plan;
d) program code for calculating a fourth cost of an individual premium for each individual in the group of individuals in the health insurance plan using the third cost;
e) program code for preparing a medical malpractice lawsuit waiver in the health insurance plan;
f) program code for receiving a first indication of a first set of individuals from the group of individuals that signed the medical malpractice lawsuit waiver;
g) program code for receiving a second indication of a second set of individuals from the group of individuals that did not sign the medical malpractice lawsuit waiver;
h) program code for calculating a fifth cost of insuring the medical service provider against potential medical malpractice claims for the group of individuals from the first indication of the first set of individuals and the second indication of the second set of individuals;
i) program code for calculating the difference between the first cost and the fifth cost of insuring the medical service provider against potential medical malpractice claims from the group of individuals;
j) program code for calculating a reduction of the fourth cost of the individual premium for each individual in the first set of individuals that signed the medical malpractice lawsuit waiver by a first percentage; and
k) program code for calculating a reduction of the second cost of the medical malpractice premium for the medical service provider by a second percentage.
